(19) United States
(12) Patent Application Publication
(10) Pub. No.: US 2014/0288847 A1
(43) Pub. Date: Sep. 25, 2014

(54) SYSTEMS AND TECHNIQUES FOR SEGMENTATION OF SEQUENTIAL DATA

(71) Applicant: THE FLORIDA STATE UNIVERSITY RESEARCH FOUNDATION, INC., TALLAHASSEE, FL (US)

(72) Inventors: Jinfeng Zhang, Tallahassee, FL (US); Jonathan Dennis, Tallahassee, FL (US); Senthil Balaji, Tallahassee, FL (US)

(73) Assignee: THE FLORIDA STATE UNIVERSITY RESEARCH FOUNDATION, INC., TALLAHASSEE, FL (US)

(21) Appl. No.: 14/216,416

(22) Filed: Mar. 17, 2014

Related U.S. Application Data
(60) Provisional application No. 61/793,239, filed on Mar. 15, 2013.

(51) Int. Cl. G06F 19/10

(52) U.S. Cl. CPC G06F 19/10
USPC 702/19

(57) ABSTRACT

An efficient method and associated systems for segmentation of high throughput sequential data, such as genomic datasets. The technique first utilizes dynamic programming to compute the significance for a large number of candidate segments. It then uses tree-based data structures to detect overlapping significant regions and update them simultaneously. Refinement and merging of significant segments are performed at the end to generate the final segmentation.

### CROSS-REFERENCE TO RELATED APPLICATIONS

This application claims priority to currently pending, the contents of which are herein incorporated by reference. This nonprovisional application is a continuation of, and claims priority to, U.S. Provisional Patent Application 61/793,239, entitled, “iSeg: An Algorithm for Segmentation of Genomic Data”, filed Mar. 15, 2013 by the same inventor(s).

### STATEMENT OF GOVERNMENT INTEREST

This invention was made with Government support under Grant No. 1R01DA033775 awarded by the National Institutes of Health. The Government has certain rights in the invention.

### BACKGROUND OF THE INVENTION

1. Field of Invention

This invention relates, generally, to the analysis of sequential data. More specifically, this invention relates to change point detection and segmentation of genomic data.

2. Brief Description of the Related Art

High throughput experiments, such as microarray and sequencing, are powerful tools for studying genetic and epigenetic functional elements at genome scale. There have been a large number of studies on the analysis of gene expression data generated from high-throughput experiments [Khatri, P. et al., Ten Years of Pathway Analysis: Current Approaches and Outstanding Challenges. PLoS Computational Biology, 8(2), 2012.]. When measuring gene expressions, the genomic locations of genes are known and multiple probes (or short reads) can be mapped to a gene to obtain its expression values. With replicates from two experimental conditions, standard hypothesis tests, such as a t-test, can be performed to infer the differentially expressed genes. On the other hand, the situation is quite different for functional elements without predefined locations (i.e. starting and ending positions). DNA copy number is one example of this situation. When detecting the changes in DNA copy number between two experimental conditions, one needs to consider a very large number of regions that can possibly undergo changes. The number is usually much larger than the total number of genes. Other functional elements, especially epigenetic features, fall into the same category. This poses a significant challenge to the analysis of these types of data.

The problem is usually formulated as segmenting a sequence of measurements along the genome. For example, if segments without changes have a mean value of zero and those with changes have nonzero means, then the goal is to identify those segments of the genome whose means are significantly above or below zero. A number of methods have been developed recently and many of those were tested on analysis of DNA copy number variations (CNVs) for microarray-based comparative genomic hybridization (aCGH) data [Baldi, P., et al., The machine learning approach, 1998; Baldi, P., et al., Bioinformatics, 17(6):509-519, 2001; Cai, T, et al., J. R. Stat. Soc., Series B*(74):773-797, 2012; Nathan Day. HMMSeg, 2007; Diskin, S. J., et al., Genome Res, 16(9): 1149-1158, September 2006; Jeng, J., et al., J. Am, Statist. Assoc., 105(491):1156-1166, 2010; Olshen, A. B., et al., Biostatistics, 5(4):557-72, October 2004; Picard, F., et al., Comput Stat Data An, 55(2):1160-1170, 2011; Picard, F., et al., Biometrics, 63(3):758-766, September 2007; Rancoita, P. M. V., et al., BMC bioinformatics, 10(1):10, 2009; Venkatraman, E. S., et al., Bioinformatics, 23(6):657-63, March 2007; Wang, K. et al., Genome Res, 17(11):1665-1674, 2007; Zhang, N R, et al., Biometrics, 63(1):22-32, 2007]. The previous methods fall into several categories including change-point detection [Baldi, P., et al., The machine learning approach, 1998; Baldi, P., et al., Bioinformatics, 17(6):509-519, 2001; Chen, J, et al., Computational Biology and Bioinformatics, IEEE/A CM Transactions on, 6(4):529-541, 2009; Chen, J, et al., J Appl Stat, 38(9):1899-1913, 2011; Niu, Y S, et al., Ann. Appl. Stat., 6(3): 1306-1326, 2012; Picard, F., et al., BMC Bioinformatics, 6(1):27, 2005; Sen, A, et al., Ann Stat, 3(1):98-108, 1975; Yao, Q W, Biometrika, 80(1):179-191, March 1993], Hidden Markov models [Nathan Day. HMMSeg, 2007; Marioni, J C, et al., Bioinformatics, 22(9): 1144-1146, 2006; Stjernqvist, S., et al., Bioinformatics, 23(8): 1006-1014, 2007; Wang, K. et al., Genome Res, 17(11):1665-1674, 2007], signal smoothing [Ben-Yaacov, E, et al., Bioinformatics, 24(16):i139-i145, 2008; Hu, J, et al., Nucleic Acids Res, 35(5):e35, 2007; Hupé, P, et al., Bioinformatics, 20(18):3413-3422, 2004; Tibshirani, R, et al., Biostatistics, 9(1): 18-29, 2008], and variational models [Morganella, S., et al., Bioinformatics, 26(24):3020-3027, 2010; Nilsson, B., et al., Bioinformatics, 25(8):1078-1079, 2009] In recent years, many efforts have been focused on developing methods for segmentation of multiple profiles simultaneously [Baladandayuthapani, V. et al., J. Am. Statist. Assoc., 105(492), 2010; Beroukhim, R., et al., Proc Natl Acad Sci, 104(50): 20007-20012, 2007; Diskin, S. J., et al., Genome Res, 16(9): 1149-1158, September 2006; Guttman, C M, et al., PLoS Genet, 3(8):e143, 08 2007; Nowak, G, et al., Biostatistics, 12(4):776-791, 2011; Picard, F., et al., Biostatistics, 12(3):413-428, 2011; Roger Pique-Regi, R, et al., Bioinformatics, 25(10):1223-1230, May 2009; Shah, S P, et al., Bioinformatics, 23(13):i450-i458, 2007; van de Wiel, M A, et al., Bioinformatics, 25(9): 1099-1104, 2009; Zhang, N R, et al., Bioinformatics, 26(2): 153-160, 2010; Zhang, N R, et al., Biometrika, 97(3):631-645, 2010; Zhang, Q, et al., Bioinformatics, 26(4):464-469, 2010; Zhang, Z, et al., BMC bioinformatics, 13(1):205, 2012; Zhou, X, et al., Computational Biology and Bioinformatics, IEEE/A CM Transactions on, 10(1):230-235, 2013].

Despite significant progress made in this area, further improvement in terms of both accuracy and computational speed is still desirable. In addition, some methods require users to adjust parameters to obtain acceptable results. The present invention provides novel and non-obvious methods and devices to address these important short-comings in the prior art.

### BRIEF SUMMARY OF THE INVENTION

The long-standing but heretofore unfulfilled need for an accurate and efficient algorithm for the segmentation of sequential data is now met by a new, useful, and nonobvious invention. The present invention provides such an algorithm, enabling segmentation of sequential data including genome-wide profiles to achieve better accuracy and efficiency compared to existing methods. In addition, the number of parameters users have to tune is minimized so that the methods taught herein can be easily applied by biologists with limited analytical expertise. The method, referred to herein as “iSeg,” has shown superior performance on both simulated data and benchmark experimental data compared with previous methods.

In a first aspect the present invention provides methods for the segmentation of sequential data. The methods include the steps of providing data representing a sequence of measurements or a set of measurements in a sequential order, selecting a representative set of segments from the data, computing a significance measure for each selected segment, detecting overlap between segments using two data structures and deleting at least one of the overlapping segments and returning the set of retained significant segments. The detecting step employs two data structures where the first data structure ranks segments by their significance measure and the second data structure stores the boundaries of each segment for overlap checking. Overlapping segments are compared against one-another and the highest ranked segment is kept, while the other segments are deleted. If a segment overlaps no other segment, it is also kept. Once all of the overlapping segments have been checked, the remaining segments are kept as “significant segments.”

In an advantageous embodiment segments are selected in the selecting step from the provided data using segments of exponentially increasing length. Alternatively, the segment length can be increased using a fixed multiplicative factor or power factor.

In a second aspect the present invention provides a second set of methods for the segmentation of sequential data. The methods include the steps of providing data representing a sequence of measurements or a set of measurements in a sequential order, selecting a representative set of segments from the data using exponentially increasing segment lengths, computing a significance measure for each selected segment, detecting overlap between segments and deleting overlapping segments with higher significance, whereby the retained segments are termed “significant segments,” and returning the set of significant segments. Alternatively, the segment length can be increased using a fixed multiplicative factor or power factor.

In an advantageous embodiment the step of detecting overlap between segments and deleting overlapping segments with higher significance measures (lower significance rankings) includes the steps of adding the segments from the computing step to the first data structure that ranks the segments by their significance measure, selecting the top-ranked segment (segment A) from the first data structure and deleting segment A from the first data structure, comparing boundaries of segment A with the boundaries of a population of segments in a second data structure that store the boundaries of the segments and adding the boundaries of segment A to the second data structure if no overlap is detected, wherein a record of segment A is kept if no overlap is detected, and repeating the detecting steps until the first data structure is empty of ranked segments.

In a third aspect the present invention provides a system for determining copy number variation of a given genomic profile consisting measures of DNA copy numbers. The system includes a computer processor and a computer-readable storage medium coupled to the processor. The storage medium has instructions tangibly embodied thereon. The instructions, when executed by the processor, cause the processor to perform the operations of computing a significance measure for each segment in the set of segments, detecting overlap between segments and deleting overlapping segments with higher significance, refining the significant segments by performing one of the following three steps: shrinking a segment expanding a segment, or merging adjacent significant segments with the aim that the new segments are more significant than the old ones and returning the set of significant segments.

In a fourth aspect the present invention provides one or more non-transitory computer-readable media having computer-executable instructions for performing a method of running a software program on a computing device, the computing device operating under an operating system. The method includes issuing instructions from the software program to communicatively access the operating system of the computing device, compute a significance measure for each segment in the set of segments, rank the segments by their significance measure, detect overlap between segments and delete overlapping segments with higher significance, refine the significant segments by shrinkage and expansion, merge adjacent refined significant segments where segments are merged with adjacent refined significant segments only when the resulting merged segment has a lower p-value than both of the pre-merged refined significant segments and store the population of post-merged significant segments.

### BRIEF DESCRIPTION OF THE DRAWINGS

For a fuller understanding of the invention, reference should be made to the following detailed description, taken in connection with the accompanying drawings, in which:

FIG. 1 is a series of nine segmentation graphs, labeled A though I, showing the simulated profiles and its detected segments obtained using iSeg. (A) FIG. 1A shows the actual data, where the true significant segments are labeled in black with an adjacent asterisk (*). The remainder of the figures show segments detected by iSeg (B) and other existing methods: snapCGH (C), mBPCR (D), cghseg (E), cghFLasso (F), HMMSeg (G), DNAcopy (H) and fastseg (I).

FIG. 2 is a graph showing a comparison of F₁-scores for the simulation profiles with SNR≅1.0. The X-axis shows the indices of the 10 profiles.

FIG. 3 is a graph showing a comparison of F₁-scores on long simulated sequences (length=100,000). The X-axis shows the indices of 10 profiles with SNR≅1.0.

FIG. 4 is a series of nine segmentation graphs, labeled A though I, showing segmentation output for one of the profiles from the Corielli dataset. The graphs provide a comparison of segmentation results obtained for the Coriell dataset. (A) The gold standard segmentation obtained using a consensus approach. Segmentation results of iSeg (B) and other existing methods: snapCGH (C); mBPCR (D); cghseg (E); cghFLasso (F); HMMSeg (G); DNAcopy (H); and fastseg (I).

FIG. 5 is a graph showing a comparison of F₁-scores obtained for the Coriell dataset. Profiles corresponding to 11 cell lines are indexed on the x-axis.

FIG. 6 is a series of nine segmentation graphs, labeled A though I, showing segmentation output for one of the profiles from the BACarray dataset. The graphs provide a comparison of segmentations for the BACarray dataset. (A) The gold standard segmentation obtained using a consensus approach for the TCGA GlioBlastoma Multiforme (GBM) profile. Segmentation results of iSeg (B) and other existing methods: snapCGH (C); mBPCR (D); cghseg (E); cghFLasso (F); HMMSeg (G); DNAcopy (H); and fastseg (I).

FIG. 7 is a graph showing a comparison of F₁-scores for BACarray dataset. Profiles corresponding to 3 cell lines are indexed on the x-axis.

FIG. 8 is a series of four graphs showing a comparison of segmentations for the TCGA dataset. The patient profile ID is TCGA-02-0007 and the data is supplied by the Harvard Medical School 244 Array CGH experiment (HMS). Segmentation results of iSeg (A) and other existing methods: DNAcopy (B); cghFLasso (C); and cghseg (D). The peaks pointed by the arrows and the region labeled by the square are identified by iSeg, but not all of them are detected by the other three methods. Overall, iSeg consistently identify all the significant peaks. Other methods often miss peaks or regions which are more significant than those they identified.

FIG. 9 is pseudo-code for the SelectSignificantSegments procedure.

FIG. 10 is pseudo-code for the SegmentExpansion (S_{i,r}) procedure.

### DETAILED DESCRIPTION OF THE PREFERRED EMBODIMENT

Identification of functional elements of a genome often requires dividing a sequence of measurements along a genome into segments, where the function or property of a segment is different from those of adjacent segments. In many applications, the mean of the measured values at multiple genomic locations in a segment is used to make inference of the property of interest. The segments with nonzero means often correspond to genomic regions with certain biological events, such as changes between two conditions. This problem is often called the segmentation problem in the field of genomics, and the change-point problem in other scientific disciplines. We designed an efficient algorithm, called iSeg, for segmentation of high-throughput genomic profiles. iSeg first utilizes dynamic programming to compute the significance for a large number of candidate segments. It then uses tree-based data structures to detect overlapping significant regions and update them simultaneously. Refinement and merging of significant segments are performed at the end to generate the final segmentation. iSeg is evaluated below using both simulated and experimental datasets. iSeg performs quite well when compared with existing methods.

Methods

Most segmentation methods have an underlying assumption of normality. For instance, a number of studies have used test statistics that are modified versions of a t-statistic. [Baldi, P., et al., Bioinformatics, 17(6):509-519, 2001; Jeng, J., et al., J. Am. Statist. Assoc., 105(491):1156-1166, 2010; Olshen, A. B., et al., Biostatistics, 5(4):557-72, October 2004] Similar assumptions are made herein, which also makes the comparison with other methods straightforward. It is worth noting that other model assumptions and statistical tests can be used in the method depending on the actual data to be analyzed. Consider a sample of length N consisting of N measurements along the genome in a sequential order, X₁, X₂, . . . , X_{N}. The common assumption is that there are M non-overlapping segments with mean μ₁, μ₂, . . . , μᵢ, . . . , μ_{M}, where μᵢ≠0, and the rest of the data points are normally distributed with mean zero. In addition, all the measurements are independent. The goal of a segmentation method is to detect all the M segments. One approach has been to first find a segment with the highest significance (or smallest p-value), remove the segment and repeat the process for the rest of the profile until all the segments with significance higher than a threshold value are identified. [Jeng, J., et al., J. Am. Statist. Assoc., 105(491):1156-1166, 2010; Olshen, A. B., et al., Biostatistics, 5(4):557-72, October 2004] There are two computational challenges associated with this approach that reduce the efficacy of many previous methods. First, the number of segments that have to be examined is very large. Second, the overlaps among significant segments need to be detected so that the significance of the overlapping segments can be adjusted accordingly. We teach a technique herein that overcomes these challenges.

To deal with the first challenge, we applied dynamic programming combined with exponentially increased segment scales to speed up the scanning of a large sequence of data points. To deal with the second challenge, we designed an algorithm coupling two balanced binary trees to quickly detect overlaps and update the list of most significant segments. Segment refinement and merging allow iSeg to detect segments of arbitrary length. The details of the technique/algorithm are given below.

Computing p-values using dynamic programming. iSeg first scans a large number of segments starting with a minimum window length, Wₘᵢₙ, and up to a maximum window length, Wₘₐₓ. They have default values 1 and 300, respectively. The window length increases by a fixed multiplicative factor, called power factor, p. For example, the shortest window length is Wₘᵢₙ, and the next shortest window length would be ρWₘᵢₙ. The default value for ρ is 1.1. When scanning with a particular window length, W, we use overlapping windows with a space of W/5. All the above-mentioned parameters can be changed by a user. We compute p-values for the selected segments and then detect the set of non-overlapping segments, which are the most significant among all the possible segments. Given the normality assumption, a standard test for whether the mean value of a segment equals zero is the one-sample student's t-test, which is also the test many previous methods are based on. The test involves calculating the test statistic

$$t = \frac{\overline{x} \sqrt{n}}{s} ,$$

where x̅ is the sample mean, s is the sample standard deviation, and n is the sample size. A drawback of this statistic is that we cannot use it to evaluate segments of length 1. This may be the reason that some of the previous methods are not good at detecting segments of length 1. Although we can derive a test statistic separately for segments of length 1, the two statistics may not be consistent. To solve this issue, we first estimate the sample standard deviation using median absolute deviation and assume this standard deviation is known. This allows us to use z statistic instead of t statistic and the significance of single points can be evaluated based on the same model assumption as longer segments. To calculate sample means for all segments to be considered for significance, a brute force approach will require (N−Wₘᵢₙ)Wₘᵢₙ+(N−ρWₘᵢₙ)ρWₘᵢₙ+ . . . +(N−ρ^{k}Wₘᵢₙ)ρ^{k}Wₘᵢₙ operations, where ρ^{k}Wₘᵢₙ≦Wₘₐₓ and ρ^{k+1}Wₘᵢₙ>Wₘₐₓ. However, computation of means and standard deviations for larger segments can be made more efficient by using the means computed for shorter segments. For example, if we keep the running sum sₜ=Σᵢ₌₁^{t} xᵢ, and compute the means for all the segments using the running sums, then the total number of operations is N+(N−Wₘᵢₙ)+(N−ρWₘᵢₙ)+ . . . +(N−ρ^{k}Wₘᵢₙ), which is much smaller in practice than the number of operations without using dynamic programming. Computation of standard deviations can be sped up in a similar way.

Detecting Overlapping Segments and Updating Significant Segments Using Balanced Binary Trees.

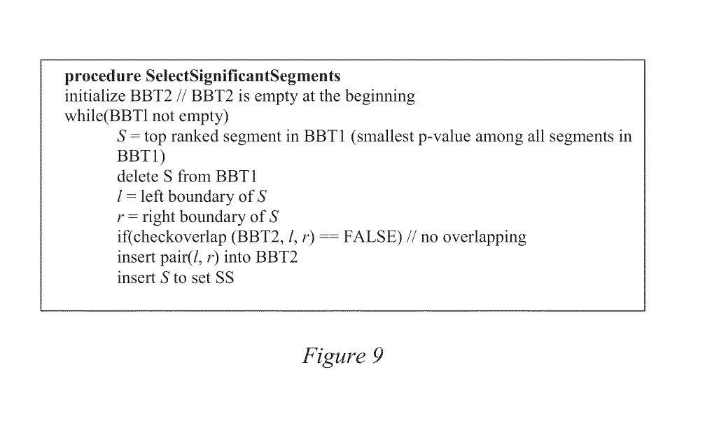

When the p-values of all the segments are computed, we rank the segments by their p-values from smallest to largest. All the segments with p-values smaller than a threshold value, pₛ, are kept in a balanced binary tree (BBT1). We set pₛ as 0.001 in this study to speed up the computation. With thousands of hypothesis tests being performed usually for a particular dataset, this cutoff is reasonable. It can be changed by a user if necessary. The procedure is described in FIG. 9 as a pseudo-code. The set SS stores all significant segments. The second balanced binary tree (BBT2) stores the boundaries for significant segments. After the procedure, SS contains all the detected significant segments.

Refinement of Significant Segments.

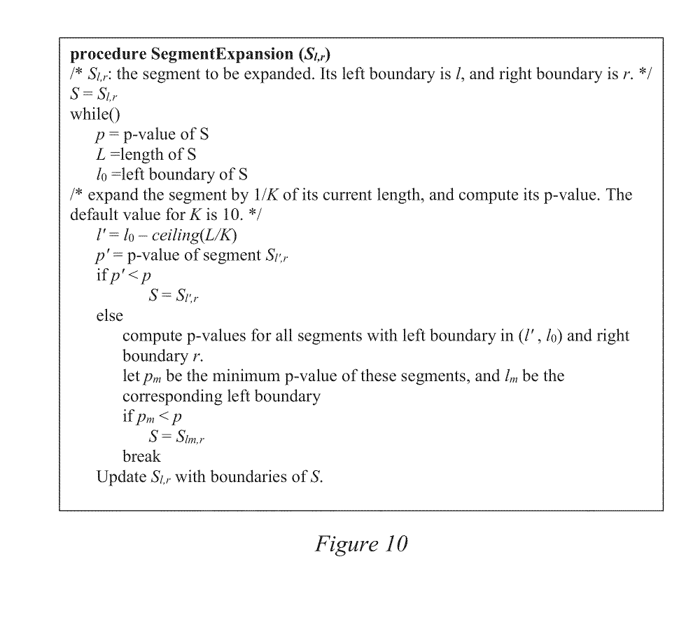

The significant segments are then refined by expansion and shrinkage. Without loss of generality, in the procedure referred to in FIG. 10 as “SegmentExpansion,” we describe expansion on left side of a segment only. Expansion on the right side and shrinkage are done similarly. When performing expansion and shrinkage, an overlap-checking condition is applied so that the procedure does not produce overlapping segments.

Merging Adjacent Significant Segments.

When all the significant non-overlapping segments are detected and refined in the previous steps, iSeg performs a final merging step to merge adjacent segments. The procedure is straightforward. We check each pair of adjacent segments. If the merged segment, whose range is defined by the left boundary of the first segment and the right boundary of the second segments, has a p-value smaller than those of individual segments, then we merge the two segments. The new segment will then be tested for merging with its adjacent segments iteratively. The procedure continues until no segments can be merged. With refinement and merging, iSeg can detect segments of arbitrary length.

Multiple Comparison.

In iSeg, p-values for potentially significant segments are calculated. Using a common p-value cutoff, for example 0.05, to determine significant segments can suffer from a large number of false positives due to multiple comparison. To cope with the multiple comparison issue, which can be very serious when the sequence of measurements are long, we use a false discovery rate (FDR) control. Specifically, we employ the Benjamini-Hochberg (B-H) procedure [Benjamini, Y, et al., J. R. Stat. Soc. Series B (Methodological), pages 289-300, 1995] to obtain a cutoff values for a predefined false discovery rate (α), which has a default value of 0.01, and can also be set by a user. Other types of cutoff values can be used to select significant segments, such as a fixed number of most significant segments.

Biological Cutoff.

Often in practice, biologists prefer to call signals above a certain threshold. For example, in gene expression analysis, a minimum of two-fold change may be applied to call differentially expressed genes. A parameter, p_{b}, can be added which can be tuned by a user to allow more flexible and accurate calling of significant segments.

Results

The iSeg was compared with several previous methods for which executable programs were available: HMMSeg [Nathan Day, N, et al., Bioinformatics, 23(11):1424-6, June 2007], CGHSeg [Picard, F., et al., Comput Stat Data An, 55(2):1160-1170, 2011], DNAcopy [Olshen, A. B., et al., Biostatistics, 5(4):557-72, October 2004; Sen, A, et al., Ann Stat, 3(1):98-108, 1975], fastseg [Baldi, P., et al., Bioinformatics, 17(6):509-519, 2001], cghFLasso [Tibshirani, R, et al., Biostatistics, 9(1): 18-29, 2008], BioHMM-snapCGH [Marioni, J C, et al., Bioinformatics, 22(9): 1144-1146, 2006] and mBPCR [Rancoita, P. M. V., et al., BMC bioinformatics, 10(1):10, 2009]. Each method has some parameters that can be tuned by a user to achieve better performance. In the comparative study, the carefully chosen parameters were based on the recommendations provided by the authors of such methods. For each method, a single set of parameters is used for all data sets. Post-processing is required by some of the methods to identify significant segments.

In the analysis, performance is measured using F₁-scores [Nancy Chinchor. MUC-4 Evaluation Metrics. In Proceedings of the Fourth Message Understanding Conference, pages 22-29, 1992] for all methods. F₁-scores are considered as a robust measure for classifiers, as they account for both precision and recall in their measurement. The F₁-score is defined as F₁=(2pr)/(p+r), where p is precision and r is recall for a classifier. In terms of the true and false positives, p=TP/(TP+FP) and r=TP/(TP+FN).

The methods CGHSeg, DNAcopy, and fastseg depend on random seeds given by a user (or at runtime automatically), and the F₁-scores at different runs are not the same, although very close. These methods were run using three different random seeds, and the averages of the F₁-scores were used to measure their performance. In the following sections, we assess iSeg's performance using both simulated data and experimental benchmark data.

Performance on Simulated Data:

The simulation profiles were generated under varying noise conditions, with signal to noise ratios (SNR) of 0.5, 1.0 and 2.0, which correspond to poor, realistic and ideal cases. Ten different profiles of length 5,000 are simulated.

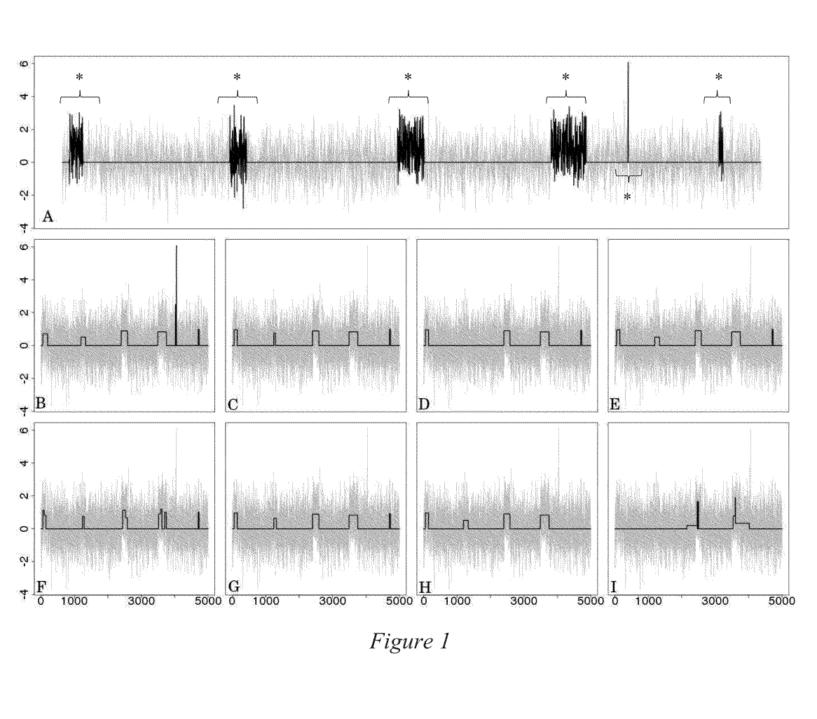

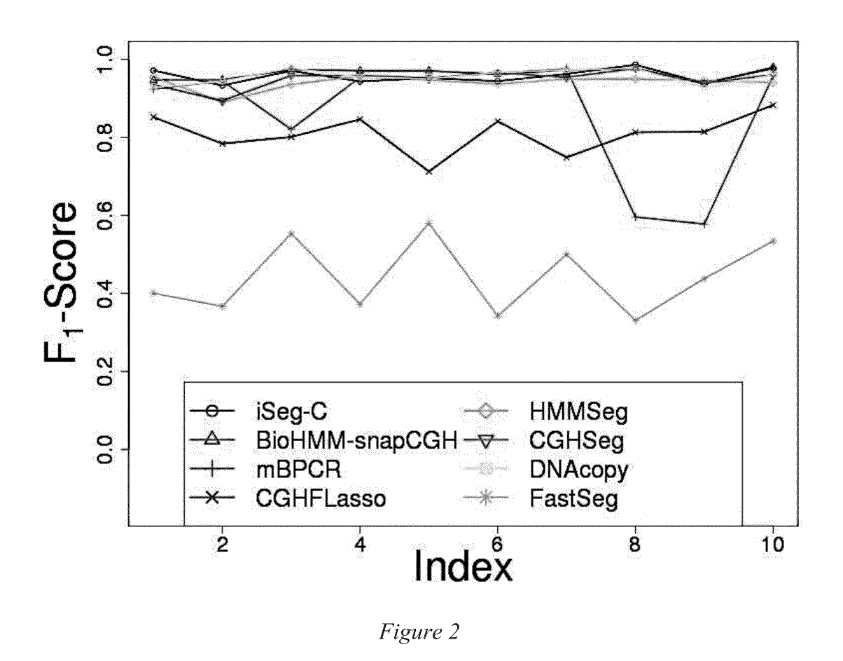

For each profile, five different segments of varying lengths are predefined at different locations. Data points outside of these segments are generated from normal distribution with mean zero. The five segments are simulated with non-zero means and varying amplitudes (some easy to detect and some rather difficult) in order to assess the robustness of the methods. FIG. 1 shows an example of the simulated data and the segments identified by iSeg and other existing methods. FIG. 2 shows the performance of iSeg and other methods on simulated data with SNR=1.0. It can be seen that iSeg, DNACopy and CGHSeg perform similarly well, with HMM and CGHFLasso performing a little worse, while fastseg did not perform as well as the other methods.

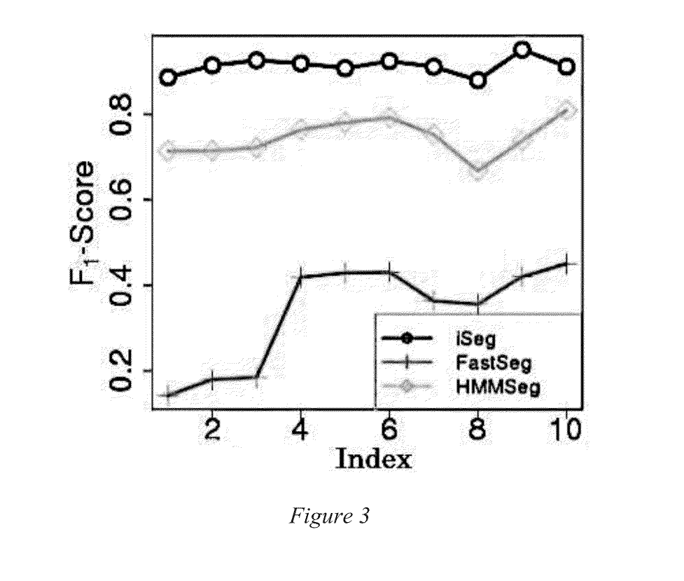

iSeg is also tested using a set of 10 longer simulated profiles, each of length 100,000. Seven segments are introduced at varying locations along the profiles. iSeg still performs quite well in these very long profiles. Since some of the methods are rather slow, we tested only fastseg and HMMSeg on this dataset. The performance of these methods is shown in FIG. 3.

Performance on Experimental Data:

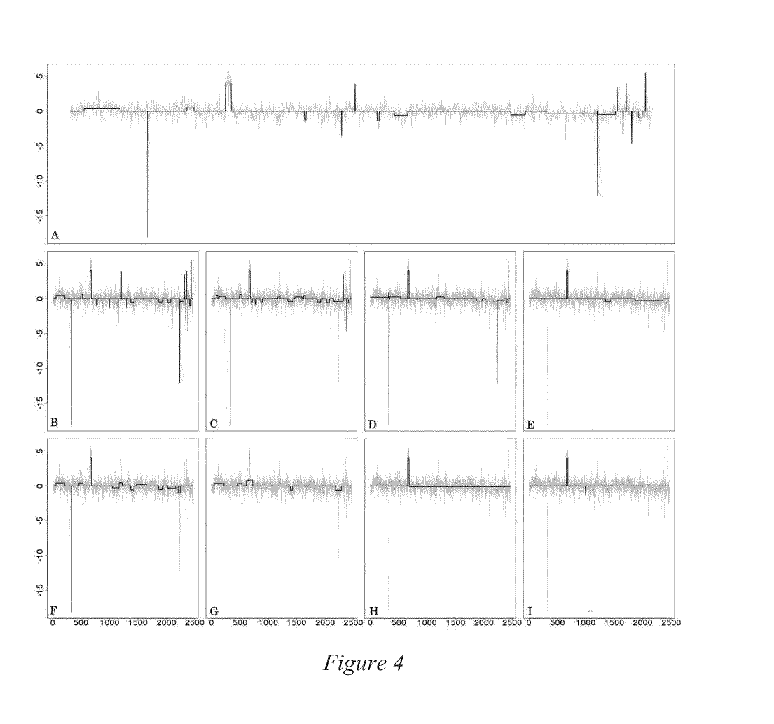

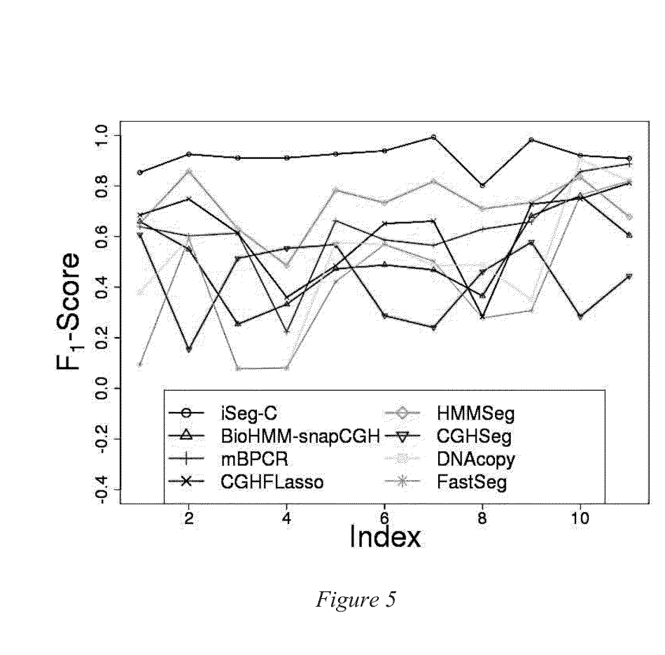

To assess the performance of iSeg on experimental data, three different datasets were employed: 11 profiles from Snijders, et al., [Snijders, A M, et al., Nat Genet, 29:263-264, 2001], called the Coriell dataset; three profiles from Wang, et al., [Wang, P, et al., Biostatistics, 6(1):45-58, 2005], called the BACarray dataset; and two profiles taken from TCGA (the Cancer Genome Atlas), called the TCGA dataset. The 11 profiles in Coriell datasets correspond to 11 cell lines: GM03563, GM05296, GM01750, GM03134, GM13330, GM01535, GM07081, GM13031, GM01524, S0034 and S1514. A “gold standard” annotations were using a consensus approach. First, all the methods were run using several different parameter settings for each method. The resulting segments are evaluated using the test statistic described in this method. The set of gold standard segments are obtained using Benjamini-Hochberg procedure to account for multiple comparisons. The 11 profiles from the Coriell dataset were segmented using iSeg and the other methods, and the F₁-scores are shown in FIG. 5. Overall, iSeg performs better than other methods in terms of F₁-scores. Its performance is also very robust with accuracy above 0.75 for all the profiles. For HMMSeg, both no-smoothing and smoothing are used. The best smoothing scale for HMMSeg was found to be 2 for the Coriell dataset. The segmentation results for one profile in Coriell dataset is shown in FIG. 4. As is evident from the figure, iSeg identified most of the segments. While DNAcopy, fastseg, HMMSeg and cghseg missed single-point peaks, cghFLasso, mBPCR and snapCGH missed some longer segments. Overall, iSeg performs better than the other methods by visual inspection, as well.

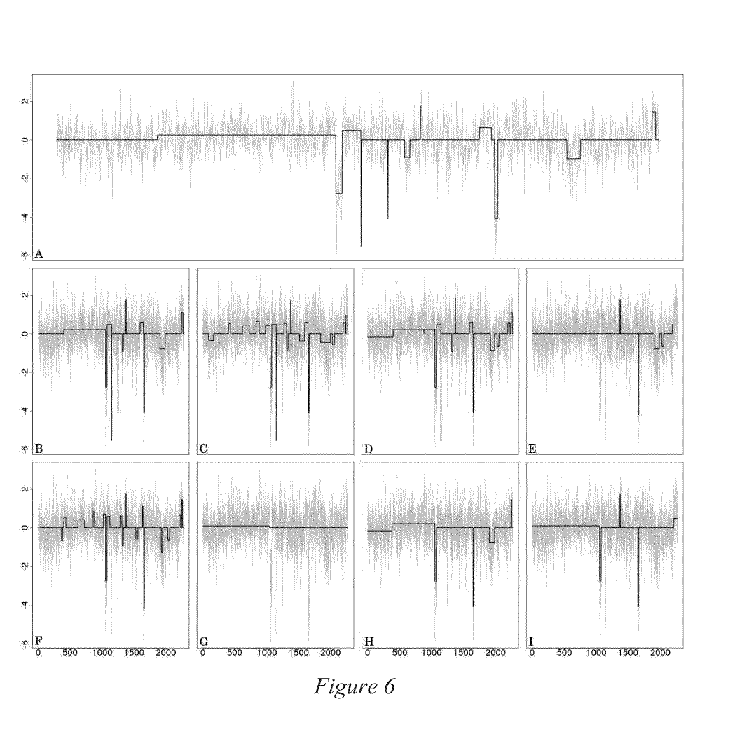

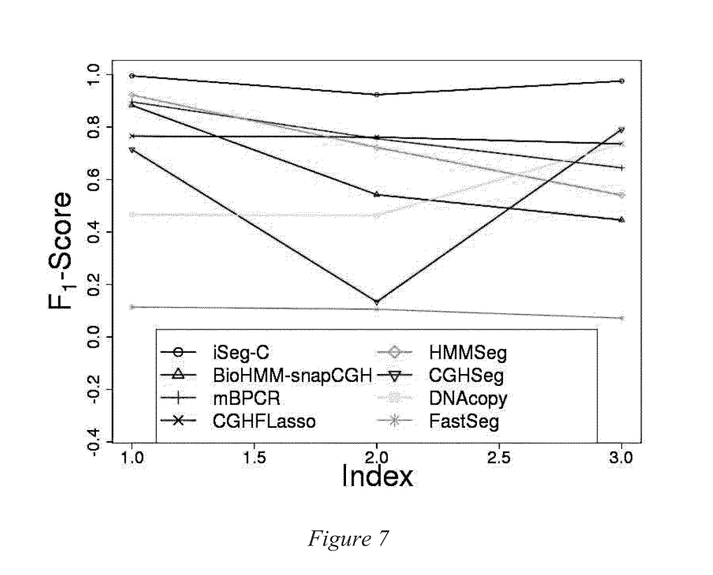

Annotations were generated using the consensus method for BACarray dataset similar to the Coriell dataset. The comparison of F₁-scores is shown in FIG. 7 and the comparison of segmentation results is shown in FIG. 6. iSeg has better F₁-scores than the other methods and a similar conclusion can also be gathered from visual inspection.

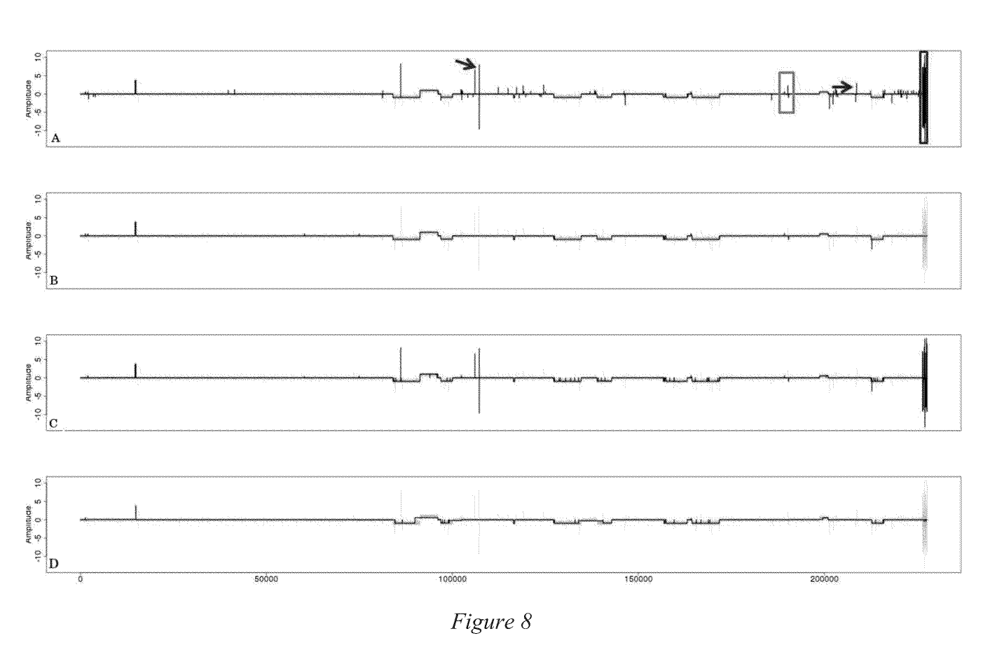

For TCGA datasets, since the profiles are comparatively long, annotations were not generated using the consensus approach. Some of the methods were applied on this dataset and their segmentation results were compared (FIG. 8). Again, it can be seen that iSeg (FIG. 8A) identified most of the significant peaks that can be detected visually. DNACopy (FIG. 8B) performs well overall, but tends to miss single-point peaks, while other methods (FIGS. 8C and 8D) do not perform as well in general.

The computational time of iSeg was compared with those of the other methods. Table 1 shows that iSeg is the fastest method for all three data sets. It is worth noting that for very long profiles (length 100,000), iSeg takes much less time than the other methods. The use of dynamic programming and a power factor makes the initial scanning of a profile fairly fast. The long profiles contain similar amount of data points that are signals (as opposed to background or noise) as the shorter profiles. The time spent on dealing with potentially significant segments is roughly the same between the two types of profiles. As a result, the overall running time of iSeg for the long profiles does not increase as much as the other methods. In summary, iSeg runs faster than the other methods, and much faster for profiles with sparse signals.

Discussion and Conclusion

An efficient method, iSeg, was designed for the segmentation of large-scale genomic profiles. When compared with existing methods using both simulated and experimental data, iSeg shows superior accuracy and speed. iSeg performs equally well when tested on very long profiles, making it suitable for real-time, online applications for large-scale genomic datasets. One assumption is that the data follow a normal distribution. The technique/algorithm is not limited to this distribution and other hypothesis tests can be used to compute p-values for the segments. It has been shown that data generated by next-generation sequencing (NGS), which has gained much popularity in genomics research, may follow a Poisson or a negative binomial distribution [Auer, P L, et al., Genetics, 185(2):405-416, 2010; Marioni, J C, et al., Genome Res, 18(9): 1509-1517, 2008]. These types of distributions should be implementable with this technique. However, normal distributions can approximate these distributions when the number of reads is relatively large.

The current method can also be used for NGS data analysis under such conditions. The use of dynamic programming and a power factor makes iSeg computationally more efficient when analyzing very long profiles, especially with sparse signals as noted in many NGS data sets. The refinement step identifies the exact boundaries of segments found by the scanning step. Merging allows iSeg to detect segments of any length. Together, these steps make iSeg an accurate and efficient method for segmentation of sequential data. Although tested only on DNA copy number data, in principle, iSeg can be used to segment other types of genomic data, such as DNA methylation and histone modifications. Some adaptation or parameter tuning may be needed for different data types. We have successfully applied the same version of iSeg to analyzing nucleosome distribution and chromatin accessibility data generated from our lab.

Jeng et al. looked at the problem of detecting and identifying sparse, short segments in a long, one-dimensional sequence and applied statistics similar to the ones used herein. [Jeng, J., et al., J. Am. Statist. Assoc., 105(491):1156-1166, 2010] Jeng et al. is based on similar model assumptions as some of the previous methods. However, in Jeng et al. the segments are identified using an exhaustive approach, which will not be efficient when the profiles to be segmented are very long. To speed up computation, the method in Jeng et al. assumes that the segments have relatively short length, which is not true for some datasets. The algorithm presented herein allows detection of segments with any length with greater efficiency.

The gold standard generated using the consensus approach does not guarantee that the true optimal segments will be identified. In addition, the F₁-scores may favor iSeg more as the test statistic used to generate the gold standard is not employed by the other methods. However, the statistic employed herein is based on model assumptions used by many existing methods and can be used in evaluating segments of length 1 or more. Some existing test statistics cannot be used for segments of length 1, which is the reason why they tend to miss such segments. Clearly, visual inspection of segmentation results shows that iSeg performs better than the other methods in this study. A natural extension of iSeg will be to compare multiple profiles simultaneously.

The iSeg method was designed to be flexible and versatile. This resulted in a number of parameters that users can tune. However, the default values work well for all the simulated and experimental datasets. In practice, to obtain satisfactory results, users are not expected to modify any parameters. The speed of iSeg allows it to be to implemented as an online tool to deliver segmentation results in real-time.

We presented the method and tested it using genomic data. However the method can be applied to other types of sequential data in other scientific disciplines, such as climate data, financial data, etc.

Hardware and Software Infrastructure Examples

The present invention may be embodied on various computing platforms that perform actions responsive to software-based instructions and most particularly on touchscreen portable devices. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++, Visual Basic or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be noted that when referenced, an “end-user” is an operator of the software as opposed to a developer or author who modifies the underlying source code of the software. For security purposes, authentication means identifying the particular user while authorization defines what procedures and functions that user is permitted to execute.

In the preceding description, numerous specific details are set forth to provide a more thorough understanding of the present invention. However, it will be apparent to one of skill in the art that the present invention may be practiced without one or more of these specific details. In other instances, well-known features and procedures well known to those skilled in the art have not been described in order to avoid obscuring the invention.

Although the present invention is described primarily with reference to specific embodiments, it is also envisioned that other embodiments will become apparent to those skilled in the art upon reading the present disclosure, and it is intended that such embodiments be contained within the present inventive methods.

### GLOSSARY OF CLAIM TERMS

Unless defined otherwise, all technical and scientific terms used herein have the same meaning as commonly understood by one of ordinary skill in the art to which this invention belongs. All publications mentioned herein are incorporated herein by reference for the purpose of describing and disclosing devices, compositions, formulations and methodologies which are described in the publication and which might be used in connection with the presently described invention.

As used herein and in the appended claims, the singular forms “a,” “an,” and “the” include plural referents unless the context clearly dictates otherwise. Thus, for example, reference to “a polymerase” refers to one agent or mixtures of such agents, and reference to “the method” includes reference to equivalent steps and methods known to those skilled in the art, and so forth.

Also as used throughout the entire application, the terms “a” and “an” are used in the sense that they mean “at least one”, “at least a first”, “one or more” or “a plurality” of the referenced components or steps, unless the context clearly dictates otherwise. For example, the term “a cell” includes a plurality of cells, including mixtures thereof.

The term “segment” means a consecutive part of a long sequence, or a sub-sequence in a long sequence.

The term “sequential data” as used herein means individual pieces of information forming or following a logical order or sequence.

The term “significance measure” as used herein means a metric for a particular numerical value, such as a test statistic computed for a segment, to represent how likely an effect (that produced this value) is not due just to chance. P-values are used as the significance measure in our exemplary method. Alternatively, one can directly use test statistics to rank or compare segments during the segmentation.

The term “length of interest” as used herein means a sequence of information or data whose properties are under investigation.

The term “dynamic programming” as used herein refers to a method for solving complex problems by breaking them down into simpler subproblems.

The term “and/or” whereever used herein includes the meaning of “and”, “or” and “all or any other combination of the elements connected by said term”.

The term “about” or “approximately” as used herein means within 20%, preferably within 10%, and more preferably within 5% of a given value or range.

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mₙ”) or weight average molecular weight (“M_{w}”), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

As used herein, the term “comprising” is intended to mean that the products, compositions and methods include the referenced components or steps, but not excluding others. “Consisting essentially of” when used to define products, compositions and methods, shall mean excluding other components or steps of any essential significance. Thus, a composition consisting essentially of the recited components would not exclude trace contaminants and pharmaceutically acceptable carriers. “Consisting of” shall mean excluding more than trace elements of other components or steps.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

TABLE 1
Table 1: Comparison of computational times (in seconds) on simulated
data and Coriell data. These are total times to process 10 simulated and
11 Coriell profiles.

| | Simulation | Simulation | |
|---|---|---|---|
| Method | (SNR≈1.0, n = 5000) | (SNR≈1.0, n = 100K) | Coriell |
| iSeg (C++) | 0.164 | 1.223 | 0.294 |
| DNAcopy (R) | 2.267 | 60.343 | 3.098 |
| fastseg (R) | 0.647 | 48.139 | 0.630 |
| CGHSeg (R) | 54.480 | 157.626 | 24.360 |
| HMMSeg | 0.543 | 160.790 | 0.552 |
| (JAVA) | | | |

What is claimed is:

1. A method for the segmentation of sequential data comprising the steps of:
providing data representing a sequence of measurements or a set of measurements in a sequential order;
selecting a representative set of segments from the data;
computing a significance measure for each selected segment;
detecting overlap between segments using two data structures, wherein the first data structure ranks segments by their significance measure and the second data structure stores the boundaries of each segment for overlap checking and wherein overlapping segments with a lower significance ranking (higher significance measure) than a highest ranked co-overlapping segment are deleted and all undeleted segments are retained as significant segments; and
returning the set of retained significant segments.

2. The method according to claim 1 wherein the significance measure is selected from the group consisting of p-values, q-values, significance level and test statistic.

3. The method according to claim 1 wherein the step of computing a significance measure for each selected segment further includes deleting segments having significance less than a threshold value according to the significance measure.

4. The method according to claim 1 wherein the step of returning the set of significant segments further comprises the step of correcting for multiple comparisons due to a large number of statistical tests being performed.

5. The method according to claim 4 wherein the step of correcting for multiple comparisons comprises applying a false discovery rate control to the set of segments according to their computed significance measures.

6. The method according to claim 4 wherein the step of correcting for multiple comparisons can comprise techniques selected from the group consisting of Bonferroni correction, methods providing control of type I error, methods based on ANOVA/Tukey's range test, and empirical methods controlling the proportion of type I errors adaptively, utilizing correlation and distribution characteristics of the observed data.

7. The method according to claim 5 wherein the Benjamini-Hochberg (B-H) procedure is used to perform the false discovery rate control.

8. The method according to claim 1 further comprising the step of applying cut-off values to select segments following the computation of their significance measure.

9. The method according to claim 1 wherein the step of returning significant segments consists of selecting a fixed number of significant segments, employing a significance measure cut-off or using the B-H procedure.

10. The method according to claim 1 further comprising the step of performing biological cut-off to select segments following the computation of their significance measure.

11. The method according to claim 1 wherein the sequences of measurement can be mapped to genomic locations or time.

12. The method according to claim 1 wherein detecting overlap between segments and deleting overlapping segments with higher significance measures (lower significance rankings) includes the steps of:
adding the segments from the computing step to the first data structure that ranks the segments by their significance measure;
selecting the top-ranked segment (segment A) from the first data structure and deleting segment A from the first data structure;
comparing boundaries of segment A with the boundaries of a population of segments in a second data structure that store the boundaries of the segments and adding the boundaries of segment A to the second data structure if no overlap is detected, wherein a record of segment A is kept if no overlap is detected; and
repeating the detecting steps until the first data structure is empty of ranked segments.

13. The method according to claim 12 wherein the data structure is selected from the group consisting of a binary tree or a similar data structure derived from a balanced binary tree and a hash table or a similar data structure derived from a hash table.

14. The method according to claim 1 further comprising the step of refining the significant segments by shrinkage, expansion, or merging adjacent segments.

15. The method according to claim 14 wherein refining the significant segments by shrinkage or expansion comprises the steps of:
providing a significant segment having a length for shrinkage or expansion;
increasing or decreasing the length of the significant segment by a defined amount to create a revised segment;
computing a significance measure for the revised segment; and
comparing the significance measure for the revised segment with the significance measure of the provided significant segment and replacing the significant segment with the revised segment if the significance measure of the revised segment is less than the significance measure of the significant segment.

16. The method according to claim 15 further comprising the step of comparing the boundaries of the revised segment with the boundaries of a set of significant segments prior to replacing the significant segment, whereby comparing ensures against segment overlap of the revised segment.

17. The method according to claim 1 wherein dynamic programming is employed to compute a significance measure for each sequence of interest in the selected population.

18. The method according to claim 1 wherein the sequence of measurement in the set of data is selected from the group consisting of genomic and epigenomic data.

19. The method according to claim 18 wherein the genomic and epigenomic data is selected from the group consisting of copy number variation, DNA methylation, histone modifications, nucleosome occupancy, chromatin accessibility, and replication time data.

20. The method according to claim 1 further comprising the step of merging adjacent significant segments wherein segments are merged with adjacent significant segments only when the resulting merged segment has a lower significance measure than both of the pre-merged refined significant segments.

21. The method according to claim 20 further comprising the step of refining the significant segments by shrinkage and expansion prior to merging.

22. The method according to claim 1 wherein segments are selected in the selecting step from the provided data using segments of exponentially increasing segment lengths.

23. A method for the segmentation of sequential data comprising the steps of:
providing data representing a sequence of measurements or a set of measurements in a sequential order;
selecting a representative set of segments from the data using exponentially increasing segment lengths;
computing a significance measure for each selected segment;
detecting overlap between segments and deleting overlapping segments with higher significance, whereby the retained segments are significant segments; and
returning the set of significant segments.

24. The method according to claim 23 wherein detecting overlap between segments and deleting overlapping segments with higher significance measures (lower significance rankings) includes the steps of:
adding the segments from the computing step to the first data structure that ranks the segments by their significance measure;
selecting the top-ranked segment (segment A) from the first data structure and deleting segment A from the first data structure;
comparing boundaries of segment A with the boundaries of a population of segments in a second data structure that store the boundaries of the segments and adding the boundaries of segment A to the second data structure if no overlap is detected, wherein a record of segment A is kept if no overlap is detected; and
repeating the detecting steps until the first data structure is empty of ranked segments.

25. The method according to claim 24 wherein the data structure is selected from the group consisting of a binary tree or a similar data structure derived from a balanced binary tree and a hash table or a similar data structure derived from a hash table.

26. A system for determining copy number variation of a given genomic profile comprising:
a. a computer processor; and
b. a computer-readable storage medium coupled to said processor, the storage medium having instructions tangibly embodied thereon, the instructions when executed by said processor causing said processor to perform the operations of:
computing a significance measure for each segment in the set of segments;
detecting overlap between segments and deleting overlapping segments with higher significance, whereby the retained segments are significant segments;
refining the significant segments by performing one of the following three steps: shrinking a segment, expanding a segment, or merging adjacent significant segments with the aim that the new segments are more significant than the old ones;
returning the set of significant segments.

27. One or more non-transitory computer-readable media having computer-executable instructions for performing a method of running a software program on a computing device, the computing device operating under an operating system, the method including issuing instructions from the software program comprising:
communicatively accessing the operating system of the computing device;
computing a significance measure for each segment in the set of segments;
ranking the segments by their significance measure;
detecting overlap between segments and deleting overlapping segments with higher significance, whereby the retained segments are significant segments;
refining the significant segments by shrinkage and expansion;
merging adjacent refined significant segments wherein segments are merged with adjacent refined significant segments only when the resulting merged segment has a lower p-value than both of the pre-merged refined significant segments;
storing the population of post-merged significant segments.
